(19) United States
(12) Patent Application Publication
(10) Pub. No.: US 2017/0221345 A1
(43) Pub. Date: Aug. 3, 2017

(54) SMART HELMET SYSTEM AND OPERATION METHOD THEREOF

(71) Applicant: AcSip Technology Corp., Taoyuan City (TW)

(72) Inventor: Cheng-Yuan CHEN, Taoyuan City (TW)

(21) Appl. No.: 15/075,752

(22) Filed: Mar. 21, 2016

(30) Foreign Application Priority Data
Feb. 3, 2016 (TW) 105103620

(51) Int. Cl. G08B 25/01; A42B 3/30; A42B 3/04

(52) U.S. Cl. CPC G08B 25/016; A42B 3/0453; A42B 3/30

(57) ABSTRACT

A smart helmet system includes a helmet and a mobile communication device. The smart helmet includes a helmet body, a detection module and a wireless transmission module. The detection module is applied to detect at least one motion parameter of the helmet. The wireless transmission module is to transmit the motion parameter. The mobile communication device stores an operation regulation to define at least one predetermined operation function of the mobile communication device corresponding to at least one set motion track. The mobile communication device is to receive the motion parameter to accordingly determine a detected motion track and further to activate the predetermined operation function when the detected motion track is complied with the set motion track, so as to operate the mobile communication device according to the predetermined operation function.

This application claims the benefit of Taiwan Patent Application Serial No. 105103620, filed Feb. 03, 2016, the subject matter of which is incorporated herein by reference.

### BACKGROUND OF INVENTION

1. Field of the Invention

The invention relates to a smart helmet system and an operation method of the smart helmet system, and more particularly to the smart helmet system and the operation method thereof that can perform corresponding predetermined operation function according to the detected motion track of the helmet.

2. Description of the Prior Art

The motorcycle is well known to be simply maneuvered, highly mobile and less expensive. Thus, the motorcycle is widely welcome both in daily life and in military service. However, while in riding the motorcycle, less human protection can be efficiently provided to the rider, except for the helmet. The helmet is one of the protection gears that can prevent the head of the rider from unexpected harm or impact while riding in the road or in a race.

In addition, it is all agreed that this decade is an era of smart phones. Each of the smart phones can be equipped with various functions, such as navigation, music entertainment, telephoning and road-side reports. When a rider rides his/her motorcycle on the road, he/she usually need the smart phone to carry out the aforesaid functions for facilitating his/her riding.

Therefore, to ensure the ride safety, the rider needs to stop aside before operating his/her smart phone. However, such a termination in journey would definitely delay his/her schedule. Since such a stop would be quite possible to miss one or two green traffic signs, so a delay in arriving his/her destination is inevitable. Further, not all roadsides can be temporarily parked for the vehicle, the rider of the motorcycle is usually unable to use his/her smart phone in an urgent need.

Further, some riders may use the smart phones while in riding their motorcycles. Such a habit would raise the risk of riding. If a rider of the motorcycle uses his/her smart phone during the riding, part of his/her focus would be definitely deviated to the smart phone. As a negative result, the rider would then loose his/her ability in perfectly maneuvering his/her motorcycle while in meeting an emergency. For example, in this situation, the rider might need at least one of his/her hands to operate the smart phone, thus rider's handling upon the motorcycle is then inevitably reduced.

Nevertheless, current helmets in the market place may provide only protection for heads, not including any change to meet the demands in the smart phones. Thus, while a rider applies the conventional helmet, the aforesaid problems involving the usage of the smart phone to the rider are still remained.

### SUMMARY OF THE INVENTION

In the art, in the situation that the rider parks his/her motorcycle at the roadside for operating his/her smart phone, the delay in arriving the destination would be highly possible. In addition, if the rider operates the smart phone and the motorcycle at the same time, focus of the rider would be then strayed, and so risk in riding is greatly increased.

Accordingly, it is the primary object of the present invention to provide a smart helmet system that includes a helmet and a mobile communication device. The helmet includes a helmet body, a detection module and a wireless transmission module. The detection module located at the helmet body is to capture at least one motion parameter of the helmet when a user wears the helmet body. The wireless transmission module located at the helmet body is electrically coupled with the detection module so as to transmit the motion parameters. The motion parameters include an acceleration, a velocity, a displacement, an angular displacement, an angular velocity and an angular acceleration.

The mobile communication device communicatively connected with the wireless transmission module is to receive the motion parameters and further includes a memory unit, a motion-analyzing module and a comparison module. The memory unit is to store an operation regulation that defines at least one predetermined operation function of the mobile communication device with respect to the at least one set motion track. The motion-analyzing module is to analyze the motion parameters and thus obtain a detected motion track. The comparison module electrically coupled with the memory unit and the motion-analyzing module is to capture and compare the detected motion track and the set motion track, to transmit an operation signal standing for the predetermined operation function with respect to the set motion track if the detected motion track is complied with the set motion track. The operation signal is used to operate the mobile communication device.

In addition, the motion parameters include a motion acceleration value of the helmet, the memory unit further has a critical impact value, the predetermined operation function further includes a call-help function, and the comparison module transmits the operation signal standing for the call-help function if the motion acceleration value is determined to be larger than the critical impact value. More precisely, when the absolute value of the motion acceleration value is greater than the critical impact value, the operation signal standing for the call-help function is transmitted. The critical impact value is always a positive number. The critical impact value is a constant, a check-table value or a derived value by a specific algorithm.

The mobile communication device further includes an auto call-help application program, the memory unit further stores communication data, and the mobile communication device applies the auto call-help application program to capture the communication data according to the operation signal standing for the call-help function, and to further issue a call-help message. The communication data includes at least one phone number for emergency contact, an instant messaging account or an email account. The call-help message includes a telephone message, an email, an instant messaging message or a call-help phone call.

The mobile communication device further includes a positioning module for generating positioning information, and the auto call-help application program automatically merges the positioning information into the call-help message according to the operation signal standing for the call-help function. The positioning module is a global positioning system (GPS). The positioning information can be merged, in a character form, into a telephone message, an email or an instant messaging message, and further, in a voice form, into a call-help phone call.

In addition, the helmet further includes a talk module electrically coupled with the wireless transmission module so as to issue the call-help message for performing a phone talk after the auto call-help application program captures the communication data. Of course, the talk module has an ear set and a speaker. While in riding the motorcycle, the talk module is introduced to perform a hand-free talk.

The helmet further includes an alert module electrically coupled with the wireless transmission module so as to issue an alert signal after receiving the operation signal standing for the call-help function. Further, the alert signal includes a voice signal or a flash signal. The purpose of the alert signal is to have the attention of adjacent people, and thereby to have these people to activate the rescue in a shortest time period.

It shall be noted that the helmet further includes a mask-displaying module electrically coupled with the wireless transmission module so as to display a display screen of the mobile communication device. Namely, the rider can know the display screen of the mobile communication device by seeing at the mask-displaying screen of the mask-displaying module, and the motion parameters are generated by the moving helmet for operating the mobile communication device.

Further, the detection module further includes a G-sensor and a Gyro sensor. The G-sensor is to detect accelerations, velocities and displacements. The Gyro sensor is to detect angular displacements, angular velocities and angular accelerations. By integrating the G-sensor and the Gyro sensor, the motion status of the helmet can be detected. Namely, the G-sensor and the Gyro sensor are applied simultaneously to capture the motion parameters of the helmet.

In addition, the wireless transmission module can be a transfer jet, a wireless universal serial bus, a dedicated short range communication (DSRC), an EnOcean, a near field communication (NFC), a ZigBee, a Bluetooth, an ultra-wide band (UWB), a wireless fidelity (WiFi) and any the like.

To apply the smart helmet system, the operation method thereof is to firstly detect the motion of the helmet and capture corresponding motion parameters, then to analyze the motion parameters so as to obtain a detected motion track, then to determine If the detected motion track is complied with a set motion track, and finally to perform a predetermined operation function with respect to the set motion track when the detected motion track is complied with the set motion track.

In addition, when the detected motion track is not complied with the set motion track, determine further if a motion acceleration value included in the motion parameters is larger than a critical impact value. Then, when the motion acceleration value is greater than a critical impact value, perform a call-help function included in the predetermined operation function. It shall mention that the call-help function is to transmit a call-help message according to a communication data. The communication data includes at least one phone number for emergency contact, an instant messaging account or an email account. The call-help message includes a telephone message, an email, an instant messaging message or a call-help phone call. The call-help message further includes positioning information.

As stated above, by providing the smart helmet system in accordance with the present invention to operate the mobile communication device, as long as the helmet moves, the detection module would capture the motion parameters of the moving helmet, the wireless transmission module would transmit the motion parameters to the mobile communication device, then the motion-analyzing module of the mobile communication device would analyze the motion parameters and further obtain a detected motion track, the comparison module would compare the detected motion track with the set motion track stored in the memory unit, and, if they both are complied, the predetermined operation function with respect to the set motion track is performed.

When the helmet meets a larger impact and the comparison module determines that the motion acceleration value of the helmet is larger than the critical impact value, then the call-help function is executed. Compared to the prior art, the present invention can save time for unnecessary parking and usage of the smart phone. Further, the safety for the rider of the motorcycle to operate the mobile device can be improved. Furthermore, in case of meeting an accident, the call-help action can be performed at the very first time, and thus time for rescue can be much improved.

All these objects are achieved by the smart helmet system and the operation method of the smart helmet system described below.

### BRIEF DESCRIPTION OF THE DRAWINGS

The present invention will now be specified with reference to its preferred embodiment illustrated in the drawings, in which:

FIG. 1 is a schematic block view for a preferred embodiment of the smart helmet system in accordance with the present invention;

FIG. 2 is a schematic view of a helmet for the smart helmet system of FIG. 1;

FIG. 3 is a schematic view of a mobile communication device and the helmet of FIG. 2 for demonstrating operations of the mask-displaying module in accordance with the present invention; and

FIG. 4 is a flowchart of an operation method for the smart helmet system of FIG. 1.

### DESCRIPTION OF THE PREFERRED EMBODIMENT

The invention disclosed herein is directed to a smart helmet system and an operation method of the smart helmet system. In the following description, numerous details are set forth in order to provide a thorough understanding of the present invention. It will be appreciated by one skilled in the art that variations of these specific details are possible while still achieving the results of the present invention. In other instance, well-known components are not described in detail in order not to unnecessarily obscure the present invention.

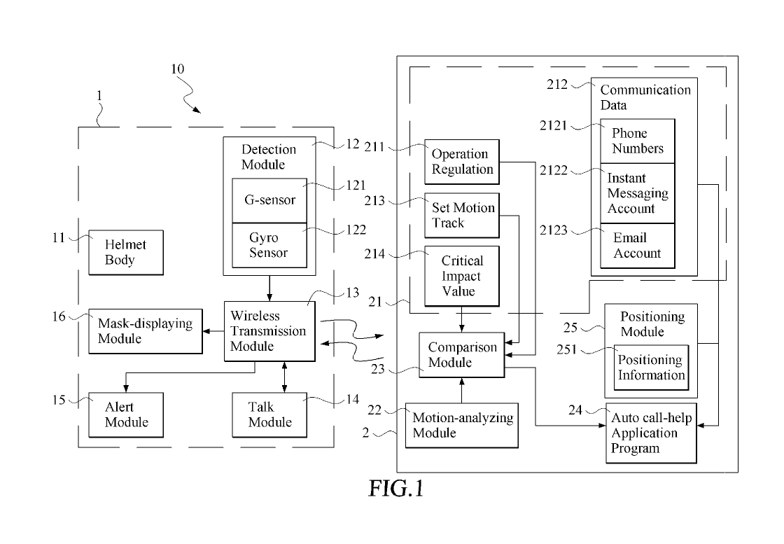

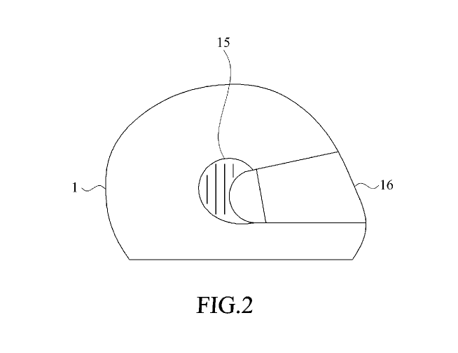

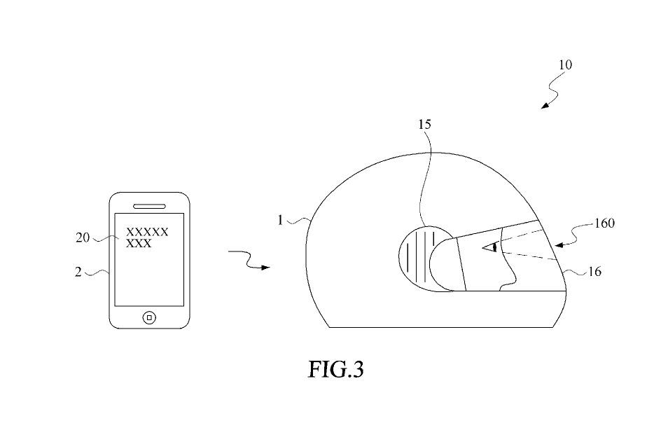

Refer now to FIG. 1, FIG. 2 and FIG. 3; where FIG. 1 is a schematic block view for a preferred embodiment of the smart helmet system in accordance with the present invention, FIG. 2 is a schematic view of a helmet for the smart helmet system of FIG. 1, and FIG. 3 is a schematic view of a mobile communication device and the helmet of FIG. 2 for demonstrating operations of the mask-displaying module in accordance with the present invention. As shown, the smart helmet system 10 of the present invention includes a helmet 1 and a mobile communication device 2. The helmet 1 further includes a helmet body 11, a detection module 12, a wireless transmission module 13, a talk module 14, an alert module 15 and a mask-displaying module 16. In the present invention, the helmet 1 can be a traffic helmet, a military helmet, a work helmet and any the like.

The detection module 12 is located at the helmet body 11, and further includes a G-sensor 121 and a Gyro sensor 122. While the helmet body 11 is worn, the detection module 12 would capture at least one motion parameter of the helmet 1. The G-sensor 121 is to detect accelerations, velocities and displacements. The Gyro sensor 122 is to detect angular displacements, angular velocities and angular accelerations. By integrating the G-sensor 121 and the Gyro sensor 122, the motion status of the helmet 1 can be precisely detected. Namely, the G-sensor 121 and the Gyro sensor 122 are activated simultaneously so as to capture various motion parameters of the helmet 1. The motion parameters include accelerations, velocities, displacements, angular displacements, angular velocities, angular accelerations and so on.

The wireless transmission module 13 is located at the helmet body 11, and is electrically coupled with the detection module 12 so as able to transmit the motion parameters. The wireless transmission module 13 can be a transfer jet, a wireless universal serial bus, a dedicated short range communication (DSRC), an EnOcean, a near field communication (NFC), a ZigBee, a Bluetooth, an ultra-wide band (UWB), a wireless fidelity (WiFi) and any the like.

The talk module 14 electrically coupled with the wireless transmission module 13 has an ear set and a speaker. While in riding a motorcycle, the talk module 14 can be operated in a hand-free manner In addition, the alert module 15 is electrically coupled with the wireless transmission module 13. The mask-displaying module 16 electrically coupled with the wireless transmission module 13 is to display a display screen 20 of the mobile communication device 2. The mask-displaying module 16 can be an organic light-emitting diode display (OLED display), a head-mounted display (HMD), a liquid crystal on silicon (LCoS) display and any the like.

The mobile communication device 2 communicatively connected with the wireless transmission module 13 is to receive the motion parameters. The mobile communication device 2 further includes a memory unit 21, a motion-analyzing module 22, a comparison module 23, an auto call-help application program 24 and a positioning module 25. The mobile communication device 2 can be a smart phone, a tablet computer, a smart watch, a personal digital assistant (PDA) and any the like.

The memory unit 21 stores an operation regulation 211, a communication data 212, at least one set motion track 213 and a critical impact value 214. The operation regulation 211 defines at least one predetermined operation function with respect to the set motion track 213. The memory unit 21 can be a dynamic random access memory (DRAM), a static random-access memory (SRAM), a read-only memory (ROM), a flash memory, a hard disk drive (HDD), a solid-state disk or drive (SSD), an online hard drive and any the like.

It shall be noted that the set motion track 213 can be preset by the system or configured by the user. The critical impact value 214 is a constant, a check-table value or a derived value by a specific algorithm. The constant can be a preset acceleration value or an acceleration value configured by the user. The table for the check-table value can be a relationship table between accelerations and velocities for relating the instant velocity to the critical impact value 214. The algorithm can be a function having at least the velocity as a variable for plugging the instant velocity to derive a corresponding critical impact value 214.

The predetermined operation function is capable of calling help, receiving a phone call, playing music, starting navigation, checking weathers, checking roadside reports and so on. By further integrated with the mask-displaying module 16, the mask-displaying screen 160 of the mask-displaying module 16 can be activated as a screen to play images on the display screen 20 of the mobile communication device 2, in which the images can include the motion parameters generated by moving the helmet 1 that can be meaningful for operating the mobile communication device 2. In particular, display contents of the mask-displaying screen 160 are exactly the same as those of the display screen 20.

In addition, the communication data 212 includes at least one phone number 2121 for emergency contact, an instant messaging account 2122 or an email account 2123. In the present invention, the instant messaging software can be the LINE, the kimo messager, the Kakao Talk, the What's App, the Wechat, the Facebook, the QQ and so on.

The motion-analyzing module 22 is to analyze the motion parameters so as to obtain a detected motion track, in which the motion parameters include a motion acceleration value of the helmet 1. The comparison module 23 electrically couples the memory unit 21 and the motion-analyzing module 22 so as to transmit an operation signal standing for the predetermined operation function with respect to the set motion track 213 while in capturing the detected motion track and the set motion track 213 and then comparing if the detected motion track is complied with the set motion track 213. The operation signal is used to operate the mobile communication device 2.

In addition, the comparison module 23 further transmits an operation signal standing for the call-help function after the motion acceleration value is determined to be larger than the critical impact value 214. In the present invention, the motion acceleration value can be positive or negative. For example, the motion acceleration value is positive if the motorcycle accelerates or is hit from behind by another vehicle. On the other hand, if the motorcycle decelerates or hits an obstacle, then the motion acceleration value is negative. More precisely, when the absolute value of the motion acceleration value is greater than the critical impact value 214, the operation signal standing for the call-help function is transmitted. It is noted that the critical impact value 214 is always a positive number.

The mobile communication device 2 introduces the auto call-help application program 24 for capturing the communication data 212 according to the operation signal standing for the call-help function and then transmitting a call-help message. In the present invention, the call-help message includes a telephone message, an email, an instant messaging message or a call-help phone call. The talk module 14 is to process the phone call after the auto call-help application program 24 captures the communication data 212 and then transmit the call-help message.

Upon receiving the operation signal standing for the call-help function, the alert module 15 issues an alert signal. Further, the alert signal includes one of a voice signal and a flash signal. The purpose of the alert signal is to have the attention of adjacent people, and thereby to have these people to activate the rescue in a shortest time period. Preferably, the alert module 15 can be a beeper, an alerting lamp or any the like.

In the present invention, the motion-analyzing module 22 or the comparison module 23 can be an application program (APP), a central processing unit (CPU), a microprocessor (R), a graphics processing unit (GPU), a physics processing unit (PPU), a digital signal processor (DSP) or any the like, and the detected motion track can be a nod-head track, a shake-head track, a circling track or any the like.

Finally, the positioning module 25 is to generate positioning information 251. The auto call-help application program 24 automatically merges the positioning information 251 into the call-help message according to the operation signal standing for the call-help function. The positioning module 25 can be a global positioning system (GPS). The positioning information 251 can be merged, in a character form, into a telephone message, an email or an instant messaging message, and further, in a voice form, into a call-help phone call.

For example, the content of the telephone message, the email, the instant messaging message or the call-help phone call can be “Hi, I am ◯◯◯. My smart helmet system detects a severe impact. Actually, I might be down by an accident, and please contact me and check if I am all right. If necessary, please rescue me! My current position is at □□□□□.”, in which the “◯◯◯” can be a user name, and “ □□□□□” is the positioning information 251. In the present invention, the positioning information 251 can be a coordinate, a landmark, an address or any the like. It shall be noted that, if the call-help message is in the form of a call-help phone call, the call-help phone call would be made after the call-help message is broadcasted, such that the user can talk to his/her emergency contact and thus the emergency contact can confirm the user's state.

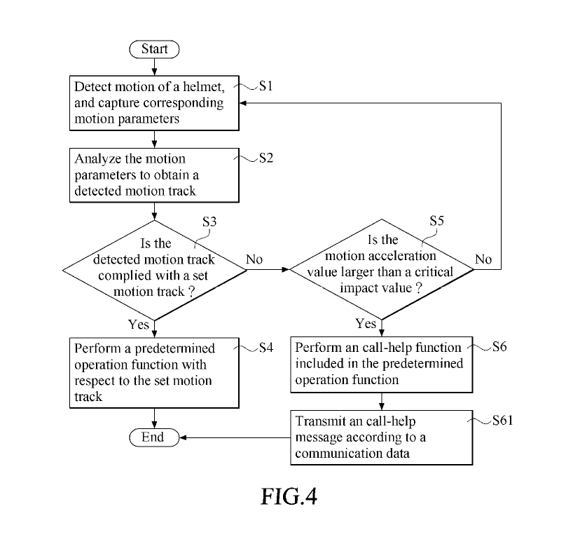

Referring now to FIG. 4, a flowchart of an operation method for the smart helmet system of FIG. 1 is shown. To apply the smart helmet system, the operation method thereof is to firstly detect the motion of the helmet and capture corresponding motion parameters (Step S1), then to analyze the motion parameters so as to obtain a detected motion track (Step S2), then to determine If the detected motion track is complied with a set motion track (Step S3), and finally to perform a predetermined operation function with respect to the set motion track when the detected motion track is complied with the set motion track (Step S4).

In addition, when the detected motion track is not complied with the set motion track, determine further if a motion acceleration value included in the motion parameters is larger than a critical impact value (Step S5). Then, when the motion acceleration value is greater than a critical impact value, perform a call-help function included in the predetermined operation function (Step S6). It shall mention that the call-help function is to transmit a call-help message according to a communication data (Step S61). The communication data includes at least one phone number for emergency contact, an instant messaging account or an email account. The call-help message includes a telephone message, an email, an instant messaging message or a call-help phone call. The call-help message further includes positioning information.

In summary, by providing the smart helmet system in accordance with the present invention to operate the mobile communication device, as long as the helmet moves, the detection module would capture the motion parameters of the moving helmet, the wireless transmission module would transmit the motion parameters to the mobile communication device, then the motion-analyzing module of the mobile communication device would analyze the motion parameters and further obtain a detected motion track, the comparison module would compare the detected motion track with the set motion track stored in the memory unit, and, if they both are complied, the predetermined operation function with respect to the set motion track is performed.

When the helmet detects a larger impact and the comparison module determines that the motion acceleration value of the helmet is larger than the critical impact value, then the call-help function is executed. Compared to the prior art, the present invention can save time for unnecessary parking and usage of the smart phone. Further, the safety for the rider of the motorcycle to operate the mobile device can be improved. Furthermore, in case of meeting an accident, the call-help action can be performed at the very first time, and thus time for rescue can be much improved.

While the present invention has been particularly shown and described with reference to a preferred embodiment, it will be understood by those skilled in the art that various changes in form and detail may be without departing from the spirit and scope of the present invention.

What is claimed is:

1. A smart helmet system, comprising:
a helmet, further including:
a helmet body;
a detection module, located at the helmet body, being to capture at least one motion parameter of the helmet when a user wears the helmet body; and
a wireless transmission module, located at the helmet body, electrically coupled with the detection module so as to transmit the motion parameters; and
a mobile communication device, communicatively connected with the wireless transmission module, receiving the motion parameters, and further including:
a memory unit, storing an operation regulation that defines at least one predetermined operation function of the mobile communication device with respect to the at least one set motion track;
a motion-analyzing module for analyzing the motion parameters and thus obtaining a detected motion track; and
a comparison module, electrically coupled with the memory unit and the motion-analyzing module, being to capture and compare the detected motion track and the set motion track, transmitting an operation signal standing for the predetermined operation function with respect to the set motion track if the detected motion track is complied with the set motion track; wherein the operation signal is used to operate the mobile communication device.

2. The smart helmet system of claim 1, wherein the motion parameters include a motion acceleration value of the helmet, the memory unit further has a critical impact value, the predetermined operation function further includes a call-help function, and the comparison module transmits the operation signal standing for the call-help function if the motion acceleration value is determined to be larger than the critical impact value.

3. The smart helmet system of claim 2, wherein the mobile communication device further includes an auto call-help application program, the memory unit further stores communication data, and the mobile communication device applies the auto call-help application program to capture the communication data according to the operation signal standing for the call-help function, and to further issue a call-help message.

4. The smart helmet system of claim 3, wherein the communication data includes at least one of a phone number for emergency contact, an instant messaging account and an email account.

5. The smart helmet system of claim 3, wherein the call-help message includes one of a telephone message, an email, an instant messaging message and a call-help phone call.

6. The smart helmet system of claim 5, wherein the mobile communication device further includes a positioning module for generating positioning information, and the auto call-help application program automatically merges the positioning information into the call-help message according to the operation signal standing for the call-help function.

7. The smart helmet system of claim 6, wherein the positioning module is a global positioning system (GPS).

8. The smart helmet system of claim 3, wherein the helmet further includes a talk module electrically coupled with the wireless transmission module so as to issue the call-help message for performing a phone talk after the auto call-help application program captures the communication data.

9. The smart helmet system of claim 3, wherein the helmet further includes an alert module electrically coupled with the wireless transmission module so as to issue an alert signal after receiving the operation signal standing for the call-help function.

10. The smart helmet system of claim 9, wherein the alert signal includes one of a voice signal and a flash signal.

11. The smart helmet system of claim 1, wherein the helmet further includes a mask-displaying module electrically coupled with the wireless transmission module so as to display a display screen of the mobile communication device.

12. The smart helmet system of claim 1, wherein the detection module further includes a G-sensor.

13. The smart helmet system of claim 1, wherein the detection module further includes a Gyro sensor.

14. The smart helmet system of claim 1, wherein the wireless transmission module includes at least one of a Bluetooth transmission module and a wireless fidelity transmission module.

15. An operation method of the smart helmet system of claim 1, comprising the steps of:
(a) detecting a motion of a helmet and capturing corresponding motion parameters;
(b) analyzing the motion parameters to obtain a detected motion track;
(c) determining if the detected motion track is complied with a set motion track; and
(d) when the detected motion track is complied with the set motion track, performing a predetermined operation function with respect to the set motion track.

16. The operation method of claim 15, further including the steps of:
(e) when the detected motion track is not complied with the set motion track, determining further if a motion acceleration value included in the motion parameters is larger than a critical impact value; and
(f) when the motion acceleration value is larger than a critical impact value, perform a call-help function included in the predetermined operation function.

17. The operation method of claim 16, in the Step (f), further including a step of:
(f1) transmitting a call-help message according to a communication data.

18. The operation method of claim 17, in the Step (f1), the communication data includes at least one of a phone number for emergency contact, an instant messaging account and an email account.

19. The operation method of claim 17, in the Step (f1), the call-help message includes one of a message, an email, an instant messaging message and a call-help phone call.

20. The operation method of claim 17, in the Step (f1), the call-help message further includes positioning information.
